(19) United States
(12) Patent Application Publication
(10) Pub. No.: US 2006/0064509 A1
(43) Pub. Date: Mar. 23, 2006

(54) Control system for controlling a plurality of target computers

(75) Inventor: Sun-Chung Chen, Hsichih (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ATEN INTERNATIONAL CO., LTD., Hsichih (TW)

(21) Appl. No.: 11/102,767

(22) Filed: Apr. 11, 2005

(30) Foreign Application Priority Data
Sep. 1, 2004 (TW) 93126428

(51) Int. Cl. G06F 15/16

(52) U.S. Cl. 709/250

(57) ABSTRACT

A control system for controlling a plurality of target computers is described. The control system has at least a local computer and a control apparatus. The local computer has a wireless signal transmission module for transmitting a local control signal. The control apparatus has a wireless signal receiving module for receiving the local control signal. The control apparatus sends the local control signal, via a KVM switch, to the target computers for controlling the target computers. The wireless signal transmission module is, for example, a general wireless card. Wireless communication can be performed using general wireless communication protocols. The wireless signal reception module is, for example, an access point.

### RELATED APPLICATIONS

The present application is based on, and claims priority from, Taiwan Application Serial Number 93126428, filed Sep. 1, 2004, the disclosure of which is hereby incorporated by reference herein in its entirety.

### BACKGROUND

1. Field of Invention

The present invention relates to a control system for controlling a plurality of target computers. More particularly, the present invention relates to a control system for controlling a plurality of target computers wirelessly.

2. Description of Related Art

Because of the advance of computer technology, complex calculations and mass storage can be achieved by using computers. A company usually needs computers to deal with records produced every day. A KVM technique allows an MIS manager of a company to input data through input devices (such as keyboard or mouse) to control remotely a plurality of target computers. For example, program management, data base management, computer system error analysis, and the share of data can be accomplished using single input device. There is no need to check each computer.

Conventionally, in a KVM system, a control apparatus is connected to computers with connection lines. The computers are usually placed in a computer room. It is inconvenient to add additional computers to the computer room when it is tightly packed with computers. Reallocation of the computers is also a problem.

Moreover, a great number of connection lines used in the conventional computer room make the whole system very complex. Therefore, the arrangement of computers is difficult and system errors may frequently happen. Once a system error occurs, it is difficult to check and fix the computer having the error. Conventional KVM systems are, for example, Switch View produced by Avocent, VP502-SAU produced by Soronti, or NET-KVMx produced by Xceedium.

Conventionally, there is another method to control a plurality of target computers through software, such as PC Anywhere. However, using software occupies a lot of computer resources. If one of the target computers crashes, the software can shut down the target computer. However, when the target computer reboots, the connection between the local computer and the target computer cannot be automatically re-established.

### SUMMARY

It is therefore an objective of the present invention to provide a control system for controlling a plurality of computers wirelessly.

It is another objective of the present invention to provide a control system for remotely controlling a plurality of target computers, where the control system can use a plurality of local computers to control a plurality of target computers simultaneously.

It is another objective of the present invention to provide a control system for remotely controlling a plurality of target computers, where the control system can use a general wireless card to control a plurality of target computers.

It is still another objective of the present invention to provide a control system for remotely controlling a plurality of target computers, where the control system can use a known wireless communication protocol to control a plurality of target computers.

It is yet another objective of the present invention to provide a control system for remotely controlling a plurality of target computers, where when one of the target computers crashes, the control system can reboot the target computer and re-establish the connection between the local computer and the target computer.

In accordance with the foregoing and other objectives of the present invention, a control system for remotely controlling a plurality of target computers is described. The control system includes at least one local computer and a control apparatus. The local computer has a wireless signal transmission module. The local computer uses the wireless signal transmission module to transmit a local control signal.

The control apparatus includes a wireless signal receiving module. The control apparatus transmits the local control signal to the target computers through a KVM switch to control the target computers. The wireless signal transmission module can be a general wireless card.

When a plurality of local computers simultaneously accesses the target computers, each local computer controls the target computers according to a corresponding priority to avoid a conflict of local signals. When one of the target computers crashes, the local computer forces the target computer to shut down and reboots the target computer, so that the local computer continues to control the target computer.

The invention has at least the following advantages and each embodiment can present one or more advantages. The control system of this invention can control a plurality of target computers wirelessly. The control system can use a plurality of local computers to control a plurality of target computers simultaneously. The control system can use a general wireless card to control a plurality of target computers. The control system can use a known wireless communication protocol to control a plurality of target computers. The target computers are controlled by hardware, so when one of the target computers crashes, the control system can reboot the target computer and re-establish the connection between the local computer and the target computer.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating an embodiment according to the invention; and

FIG. 2 is a block diagram illustrating a control apparatus according to the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

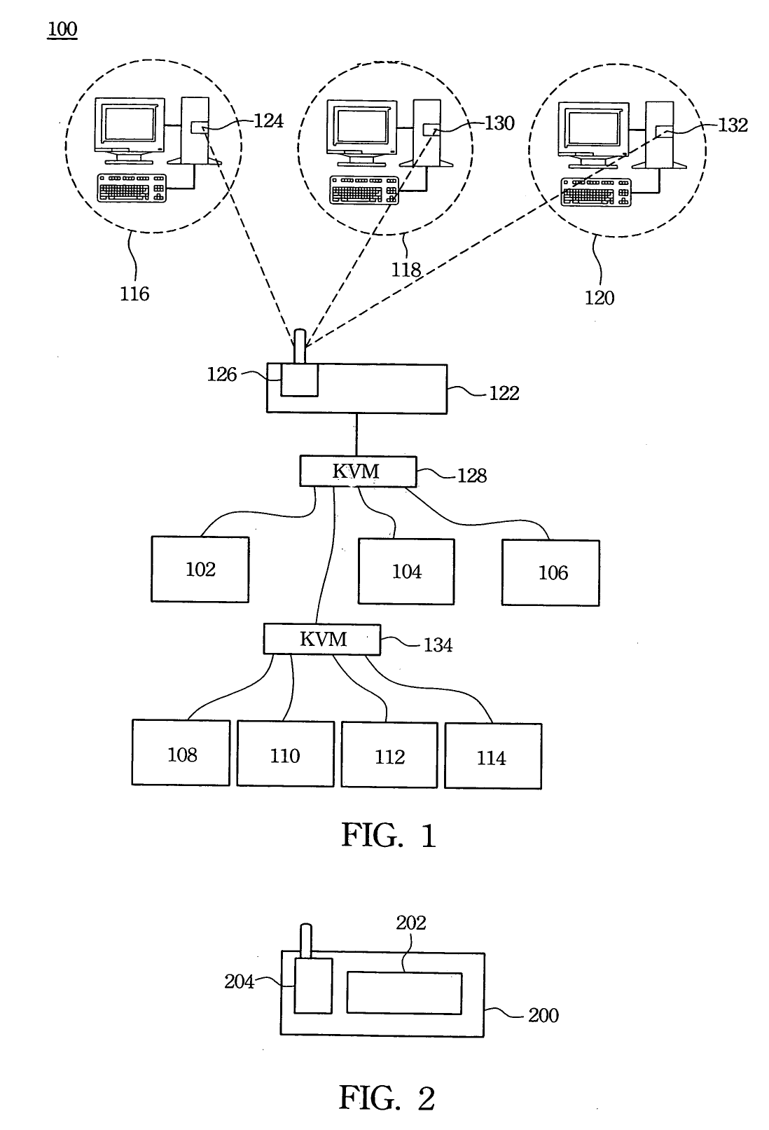

FIG. 1 is a diagram illustrating an embodiment according to the invention. With reference to FIG. 1, a control system 100 is used to control remotely a plurality of target computers (102-114). The control system 100 includes at least one local computer (116-120) and a control apparatus 122.

Conventionally, the control apparatus 122 is connected to the local computer 116, 118, and 120 with connection lines. The local computers 116, 118, and 120 are usually placed in a computer room. It is inconvenient to add additional computers to the computer room that is tightly packed with computers. Reallocation of the computers is also a problem.

Moreover, a great number of connection lines used in the conventional computer room make the whole system very complex. Therefore, the arrangement of computers is difficult and system errors may frequently happen. Once a system error occurs, it is difficult to check and fix the computer having the error. Conventional KVM systems are, for example, Switch View produced by Avocent, VP502-SAU produced by Soronti, or NET-KVMx produced by Xceedium. To resolve the long-standing problems mentioned above, the invention adopts wireless communication to avoid these problems.

With reference to FIG. 1, a local computer, such as 116, has a wireless signal transmission module 124. The local computer 116 transmits a local control signal through the wireless signal transmission module 124.

A control apparatus 122 has a wireless signal receiving module 126. The control apparatus 122 receives the local control signal through wireless signal receiving module 126. The control apparatus 122 transmits the local control signal to the target computers (102-114) through a KVM switch 128 to control the target computers (102-114).

The wireless signal transmission module 124 is, for example, a general wireless card. The wireless signal receiving module 126 is, for example, a wireless access point. In this embodiment, the communication protocol for the wireless signal transmission module 124 and the wireless signal receiving module 126 is, for example, 802.11a, 802.11b, or 802.11g. The wireless signal receiving module 126 (such as a wireless access point) can support the communication protocols mentioned above. These protocols are known. The wireless signal transmission module is not limited to a particular hardware or protocol. Any wireless card available on the market can be installed in the local computer 116.

In one embodiment, the wireless signal transmission module 124 has a wireless signal receiving function, and the wireless signal receiving module 126 has a wireless signal transmitting function. Thus, the local computer 116 and the target computers (102-114) can communicate signals. The control system 100 can use a plurality of local computers (116-120) to control simultaneously a plurality of target computers (102-114). The local computer 118 and 120 can use wireless signal transmission module 130 and 132 to transmit local control signals to the wireless signal receiving module 126. At this time, each local computer controls the target computers (102-114) according to a corresponding priority to avoid a conflict of the local signals. The corresponding priority is used to limit a control authority of at least one target computer.

For example, when the local computer 116 has controlled the target computers 102, 104, and 106, the local computer 118 and 120 cannot control the target computers 102, 104, and 106. The local computer 118 and 120 can only used a “Read Only” method to browse the control images of the target computers 102, 104, and 106. In other words, the control authorities of the local computers 118 and 120 are limited.

In another embodiment, the priority of the local computer 116 is only limited to the target computer 102. The priority of the local computer 118 is only limited to the target computers 108, 110, 112, and 114. The priority of the local computer 120 is only limited to the target computers 104, and 106. Thus, each local computer has its own priority to control specific target computers. A system for a plurality of local computers to control a plurality of target computers can be established.

Controlling a plurality of target computers needs good network security to avoid information divulgence. For example, before the local computer 116 transmits the local control signal through the wireless signal transmission module 124, the local computer 116 encrypts the local control signal. The control apparatus 122 decrypts the local signal after receiving the local control signal through the wireless signal receiving module 126. Thus, information divulgence is avoided.

One advantage in realizing the control of a plurality of target computers by hardware is that it can deal with a condition where a target computer crashes. For example, the local computer 116 forces the target computer 102 to shut down and reboots the target computer 102, so that the local computer 116 continues to control the target computer 102. The local computer 116 can monitor the system boot screen and change the BIOS parameters. The target computers (102-114) can have different operating systems.

The local computer (116-120) can use a browser as an interface to control the target computers (102-114). The local computers (116-120) can also use specific software as an interface to control the target computers (102-114). When the local computers (116-120) control the target computers (102-114), the local computers (116-120) can select parameters of the target computers from a menu shown on a display of at least one of the local computers (116-120). The menu is, for example, an OSD (one screen display). A local computer can select its target computers from the menu.

As shown in FIG. 1, the KVM switch 128 can be connected to another KVM switch 134 to expand hierarchically the number of the target computers. The expansion can also be called a cascade expansion. The target computers (108-114) can be added to the control system 100 through the KVM switch 134.

FIG. 2 is a block diagram illustrating a control apparatus according to the invention. With reference to FIG. 2, the application of the control apparatus 200 is shown in FIG. 1. The control apparatus 200 includes a control circuit 202 and a wireless signal receiving module 204. The control circuit 202 is used to receive a local control signal. The control circuit 202 receives a local control signal. Referring to FIG. 1 and FIG. 2, the control apparatus 200 is equal to the control apparatus 122. The control circuit 202 transmits the local control signal to the target computers (102-114) through a KVM switch 128 to control the target computers (102-114). The wireless signal receiving module 204 receives the local control signal from at least one local computer (such as 116) and transmits the local control signal to the control circuit 202. The way of controlling a plurality of target computers (102-114) is the same as in FIG. 1.

The invention has at least the following advantages and each embodiment can present one or more advantages. With reference to the embodiments described above, the control system 100 of this invention can control a plurality of target computers (102-114) wirelessly. The control system 100 can use a plurality of local computers (116-120) to control a plurality of target computers (102-114) simultaneously. The control system 100 can use a general wireless card to control a plurality of target computers (102-114). The control system 100 can use a known wireless communication protocol to control a plurality of target computers (102-114). The target computers (102-114) are controlled by hardware, so when one of the target computers (102-114) crashes, the control system 100 can reboot the target computer and re-establish the connection between the local computer and the target computer.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control system for remotely controlling a plurality of target computers, the control system comprising:
at least one local computer, the local computer comprising a wireless signal transmission module, wherein the local computer uses the wireless signal transmission module to transmit a local control signal; and
a control apparatus, the control apparatus comprising a wireless signal receiving module, wherein the control apparatus receives a local control signal through the wireless signal receiving module, and the control apparatus transmits the local control signal to the target computers through a KVM switch to control the target computers.

2. The control system of claim 1, wherein the wireless signal transmission module is a general wireless card.

3. The control system of claim 1, wherein the wireless signal receiving module is a wireless access point.

4. The control system of claim 1, wherein the wireless signal transmission module has a wireless signal receiving function, and the wireless signal receiving module has a wireless signal transmitting function, whereby the local computer and the target computers communicate signals.

5. The control system of claim 1, wherein when a plurality of local computers simultaneously access the target computers, each local computer controls the target computers according to a corresponding priority to avoid a conflict of local signals.

6. The control system of claim 5, wherein the corresponding priority is used to limit a control authority of at least one target computer.

7. The control system of claim 1, wherein (i) before the local computer transmits the local control signal through the wireless signal transmission module, the local computer encrypts the local control signal, and (ii) the control apparatus decrypts the local signal after receiving the local control signal through the wireless signal receiving module.

8. The control system of claim 1, wherein when one of the target computers crashes, the local computer forces the target computer to shut down and reboots the target computer, so that the local computer continues to control the target computer.

9. The control system of claim 1, wherein the target computers have different operating systems.

10. The control system of claim 1, wherein the local computer uses a browser as an interface to control the target computers.

11. The control system of claim 1, wherein the local computer selects parameters of the target computers from a menu shown on a display of the local computer.

12. The control system of claim 1, wherein the KVM switch is connected to another KVM switch to expand hierarchically a number of the target computers.

13. A control apparatus for remotely controlling a plurality of target computers, the control apparatus comprising:
a control circuit for receiving a local control signal, the control circuit transmitting the local control signal to the target computers through a KVM switch to control the target computers; and
a wireless signal receiving module for receiving the local control signal from at least one local computer and transmitting the local control signal to the control circuit.

14. The control apparatus of claim 13, wherein the local computer comprises a wireless signal transmission module, and the local computer uses the wireless signal transmission module to transmit the local control signal.

15. The control apparatus of claim 14, wherein the wireless signal transmission module is a general wireless card.

16. The control apparatus of claim 14, wherein the wireless signal transmission module has a wireless signal receiving function, and the wireless signal receiving module has a wireless signal transmitting function, whereby the local computer and the target computers communicate signals.

17. The control apparatus of claim 13, wherein the wireless signal receiving module is a wireless access point.

18. The control apparatus of claim 13, wherein when a plurality of local computers simultaneously accesses the target computers, each local computer controls the target computers according to a corresponding priority to avoid a conflict of local signals.

19. The control apparatus of claim 18, wherein the corresponding priority is to limit a control authority of at least one target computer.

20. The control apparatus of claim 13, wherein (i) before the local computer transmits the local control signal through the wireless signal transmission module, the local computer encrypts the local control signal, and (ii) the control apparatus decrypts the local signal after receiving the local control signal through the wireless signal receiving module.

21. The control apparatus of claim 13, wherein when one of the target computers crashes, the local computer forces the target computer to shut down and reboots the target computer, so that the local computer continues to control the target computer.

22. The control apparatus of claim 13, wherein the target computers have different operating systems.

23. The control apparatus of claim 13, wherein the local computer uses a browser as an interface to control the target computers.

24. The control apparatus of claim 13, wherein the local computer selects parameters of the target computers from a menu shown on a display of the local computer.

25. The control apparatus of claim 13, wherein the KVM switch is connected to another KVM switch to expand hierarchically a number of the target computers.
